(19) United States
(12) Patent Application Publication
(10) Pub. No.: US 2006/0164695 A1
(43) Pub. Date: Jul. 27, 2006

(54) Automatic document feeder, apparatus for scanning image, apparatus for processing image, method and program for feeding sheet

(75) Inventor: Akihito Tokutsu, Yokohama-shi (JP)

Correspondence Address: FOLEY AND LARDNER LLP;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 11/038,179

(22) Filed: Jan. 21, 2005

(51) Int. Cl. H04N 1/04

(52) U.S. Cl. 358/498

(57) ABSTRACT

To provide a technique of feeding plural sheets while their sheet spacing kept suitable, with a simple configuration. There is provided an automatic document feeder that consecutively feeds plural documents to a predetermined scanning position of an apparatus for scanning an image, comprising: a speed information acquiring unit that acquires speed information concerning a scanning-feeding speed or the feeding speed of a document whose image is to be scanned at the predetermined scanning position; a temporal information acquiring unit that acquires temporal information concerning a time interval from the time point when sending a document to a feed path is started to the time point when the sent document arrives at the vicinity of the upstream of a register roller that performs feeding timing adjustment for the sent document and feeds the document; and a control unit that, based on speed information acquired by the speed information acquiring unit concerning an anterior document which is fed previously and temporal information acquired by the temporal information acquiring unit concerning a posterior document which is to be fed after the anterior document is fed, controls the register roller so that the posterior document is fed at a speed higher than the scanning-feeding speed of the anterior document.

### BACKGROUND OF THE INVENTION

1. Field of the Invention

The present invention relates to an automatic document feeder, an apparatus for scanning an image, an apparatus for processing an image, a method for feeding a sheet, and a program for feeding a sheet, and more particularly, to controlling the speed of feeding a sheet.

2. Description of the Related Art

When consecutively feeding and scanning plural documents using an ADF (Automatic Document Feeder), from a viewpoint of efficiency in scanning documents, it is desired that the feeding speed be controlled so that the spacing between thus consecutively fed documents comes to be suitable.

Conventionally, there is known a technique (Jpn. Pat. Appln. Laid-Open Publication No. 2001-31284), in which plural documents are placed on a paper feed tray of an ADF, and which includes a separating-feeding section which separates plural documents one by one and feeds thus separated documents, a scanning-feeding section which feeds thus fed documents to a scanning position, and a control section. When an anterior document is being scanned, the next document is separated and made to be on standby, and the currently scanned document and the next document are separated to get to a predetermined spacing, the next document is fed to a predetermined position located at the upstream of the scanning position at a speed higher than the feeding speed at the time of scanning so as to reduce the spacing of anterior and posterior documents.

However, in the above conventional technique, a complicated control is necessary in which feeding of the next document is started while monitoring the scanning status of the currently scanned document. Furthermore, a front sensor to detect the arrival timing of the front of a document to change the document feeding speed is necessary, which raises a cost problem.

### SUMMARY OF THE INVENTION

It is therefore an object of the present invention to overcome the above-mentioned drawbacks by providing a technique of feeding plural sheets while their sheet spacing kept suitable, with a simple configuration.

In order to solve the above-mentioned problems, an automatic document feeder according to the present invention that consecutively feeds plural documents to a predetermined scanning position of an apparatus for scanning an image, comprising: a speed information acquiring unit that acquires speed information concerning a scanning-feeding speed or the feeding speed of a document whose image is to be scanned at the predetermined scanning position; a temporal information acquiring unit that acquires temporal information concerning a time interval from the time point when sending a document to a feed path is started to the time point when the sent document arrives at the vicinity of the upstream of a register roller that performs feeding timing adjustment for the sent document and feeds the document; and a control unit that, based on speed information acquired by the speed information acquiring unit concerning an anterior document which is fed previously and temporal information acquired by the temporal information acquiring unit concerning a posterior document which is to be fed after the anterior document is fed, controls the register roller so that the posterior document is fed at a speed higher than the scanning-feeding speed of the anterior document.

Further, an apparatus for scanning an image according to the present invention, comprises: an automatic document feeder having a configuration described above; and an image scanning unit that scans an image of a document which is fed to the predetermined scanning position by the automatic document feeder, wherein the scanning-feeding speed is set up based on contents of an image scanning operation by the image scanning unit.

Further, an apparatus for processing an image according to the present invention, comprises: an automatic document feeder having a configuration described above; an image scanning unit that scans an image of a document which is fed to the predetermined scanning position by the automatic document feeder; and an image forming unit that forms an image which is scanned by the image scanning unit on a sheet, wherein the scanning-feeding speed is set up based on contents of an image formation operation by the image forming unit.

Further, a method for feeding a sheet according to the present invention that consecutively feeds plural documents to a predetermined scanning position of an apparatus for scanning an image, comprising: a speed information acquiring step of acquiring speed information concerning a scanning-feeding speed or the feeding speed of a document whose image is to be scanned at the predetermined scanning position; a temporal information acquiring step of acquiring temporal information concerning a time interval from the time point when sending a document to a feed path is started to the time point when the sent document arrives at the vicinity of the upstream of a register roller that performs feeding timing adjustment for the sent document and feeds the document; and a control step of, based on speed information acquired at the speed information acquiring step concerning an anterior document which is fed previously and temporal information acquired at the temporal information acquiring step concerning a posterior document which is to be fed after the anterior document is fed, controlling the register roller so that the posterior document is fed at a speed higher than the scanning-feeding speed of the anterior document.

Furthermore, a program for feeding a sheet according to the present invention that makes a computer carry out the processing of consecutively feeding plural documents to a predetermined scanning position of an apparatus for scanning image, the program making the computer carry out: a speed information acquiring step of acquiring speed information concerning a scanning-feeding speed or the feeding speed of a document whose image is to be scanned at the predetermined scanning position; a temporal information acquiring step of acquiring temporal information concerning a time interval from the time point when sending a document to a feed path is started to the time point when the sent document arrives at the vicinity of the upstream of a register roller that performs feeding timing adjustment for the sent document and feeds the document; and a control step of, based on speed information acquired at the speed information acquiring step concerning an anterior document which is fed previously and temporal information acquired at the temporal information acquiring step concerning a posterior document which is to be fed after the anterior document is fed, controlling the register roller so that the posterior document is fed at a speed higher than the scanning-feeding speed of the anterior document.

### BRIEF DESCRIPTION OF THE DRAWINGS

FIG. 1 shows a cross-sectional view of the entire configuration of an automatic document feeder, apparatus for scanning an image, and apparatus for processing an image according to the present embodiment;

FIG. 2 shows a longitudinal cross-sectional view for explaining the configuration of the automatic document feeder according to the embodiment;

FIG. 3 shows a block diagram of the image processing apparatus according to the embodiment;

FIG. 4 shows a flow chart for explaining the flow of the processing of a method for feeding a sheet according to the embodiment;

FIG. 5 shows a flow chart for explaining the flow of the processing of the method for feeding a sheet according to the embodiment;

FIG. 6 shows a flow chart for explaining the flow of the processing of the method for feeding a sheet according to the embodiment;

FIG. 7 shows a flow chart for explaining the flow of the processing of the method for feeding a sheet according to the embodiment;

FIG. 8 shows a flow chart for explaining the flow of the processing of the method for feeding a sheet according to the embodiment;

FIG. 9 shows a flow chart for explaining the flow of the processing of the method for feeding a sheet according to the embodiment; and

FIG. 10 shows a timing chart of sheet feeding by the automatic document feeder according to the embodiment.

### DETAILED DESCRIPTION OF THE PREFERRED EMBODIMENTS

An embodiment of the present invention will be described below with reference to the accompanying drawings.

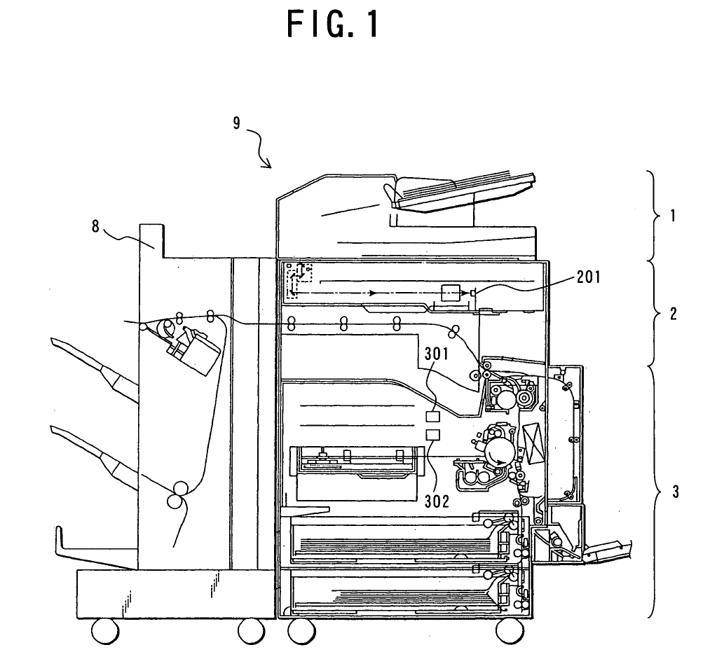

FIG. 1 shows a cross-sectional view of the entire configuration of an automatic document feeder, apparatus for scanning an image, and apparatus for processing an image according to the present embodiment.

An image processing apparatus 9 of the embodiment includes an ADF (automatic document feeder) 1 that can consecutively feed plural sheet documents, an image scanning apparatus (image scanning unit) 2 that scans images of documents, an image forming apparatus (image forming unit) 3 that forms images on sheets, and a post-processing apparatus 8 that performs post-processing such as sort processing and staple processing for sheets having images formed by the image forming apparatus 3. The image processing apparatus 9 can also perform copy processing of forming document images scanned by the image scanning apparatus 2 on sheets at the image forming apparatus 3. The image forming apparatus 3 has a CPU 301 that performs operation for various processing of the entire image processing apparatus 9, and a memory 302 that stores information utilized in the image processing apparatus 9 and programs etc. carried out in the same apparatus.

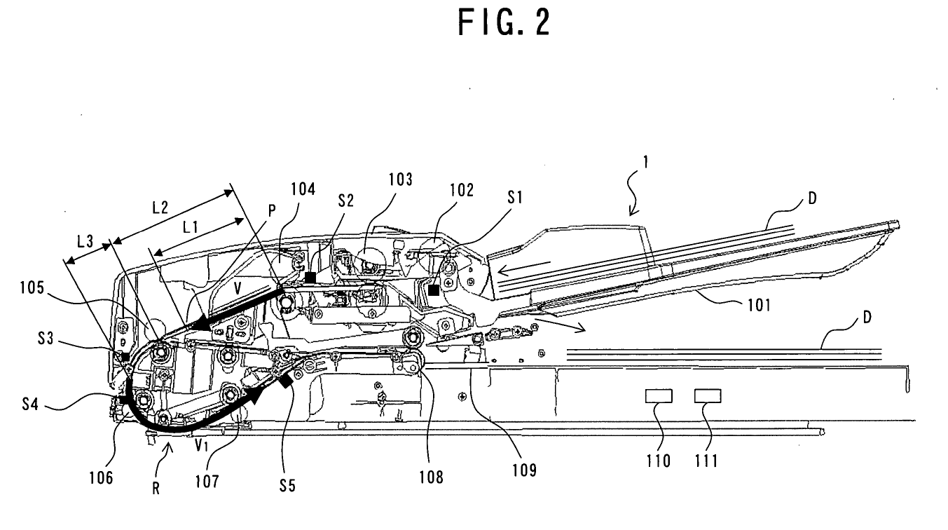

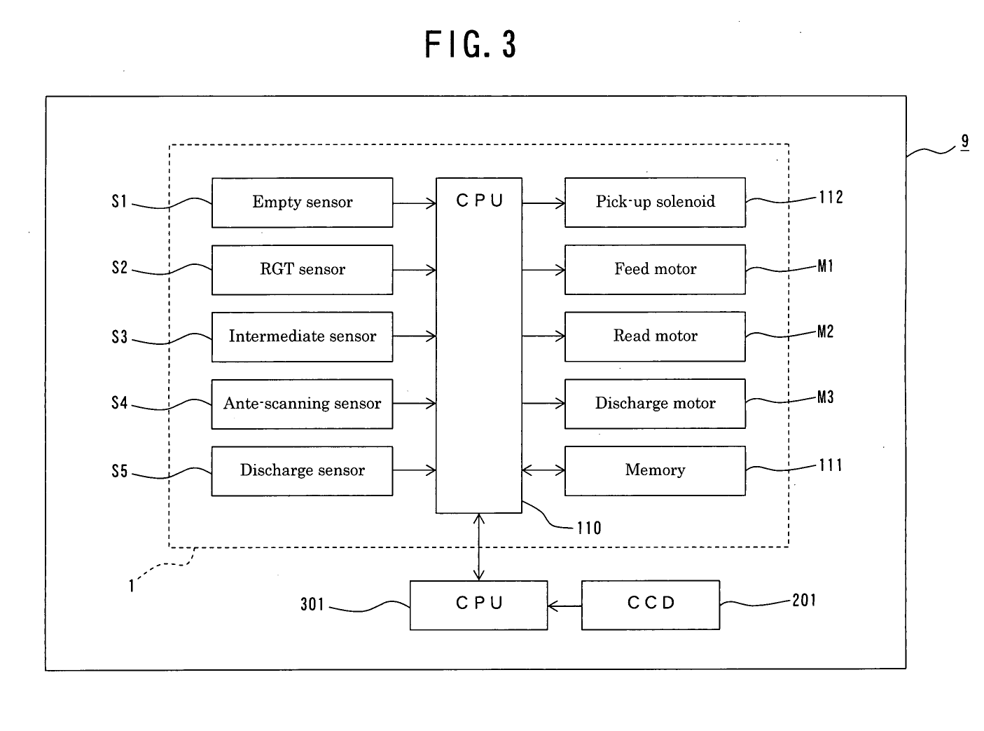

FIG. 2 shows a longitudinal cross-sectional view for explaining the configuration of the automatic document feeder according to the embodiment, while FIG. 3 shows a block diagram of the image processing apparatus according to the embodiment.

The automatic document feeder 1 of the embodiment includes a paper feed tray 101, a pick-up roller 102, a separating-feeding roller 103, an RGT roller 104, an intermediate feeding roller 105, an ante-scanning roller 106, a post-scanning roller 107, a discharge roller 108, a catch tray 109, an empty sensor S1, an RGT sensor S2, an intermediate sensor S3, an ante-scanning sensor S4, a discharge sensor S5, a CPU 110, and a memory 111.

The pick-up roller 102 picks up sheet documents (referred to as sheets, hereinafter) D placed on the paper feed tray 101, and feeds thus picked up sheets to a sheet feed path. The separating-feeding roller 103 separates the sheets D provided by the pick-up roller 102 one by one. The RGT roller (register roller) 104 feeds the sheet D provided on the feed path at an arbitrary feeding speed, and performs feeding timing adjustment and oblique passing compensation for the sheet.

The intermediate feeding roller 105 is arranged at the upstream of the ante-scanning roller 106, to be described later, on the sheet feed path (at the upstream of a predetermined scanning position R along the feeding direction), and feeds the sheet D sent from the RGT roller 104 at a suitable feeding speed for the ante-scanning roller 106 to receive the sheets.

The ante-scanning roller 106 is arranged at the upstream of the document scanning position R on the sheet feed path, while the post-scanning roller 107 is arranged at the downstream of the document scanning position R on the sheet feed path. The discharge roller 108 discharges the sheet D whose image scanning is completed, to the catch tray 109.

The separating-feeding roller 103 and the RGT roller 104 are driven to be rotated by a feed motor M1 (refer to FIG. 3), while the discharge roller 108 is driven to be rotated by a discharge motor M3 (refer to FIG. 3). The pick-up roller 102, intermediate feeding roller 105, ante-scanning roller 106, and post-scanning roller 107 are driven to be rotated by a read motor M2 (refer to FIG. 3).

The empty sensor S1 senses the existence of the sheets D placed on the paper feed tray 101. The RGT sensor S2 is arranged at the upstream of the RGT roller 104 on the sheet feed path, and senses the leading end of the sheet D sent to the vicinity of the upstream of the RGT roller 104. The intermediate sensor S3 is arranged at the downstream of the intermediate feeding roller 105 on the sheet feed path, and senses the leading end of the sheet D passing through the intermediate feeding roller 105. The ante-scanning sensor S4 is arranged at the upstream of the ante-scanning roller 106 on the sheet feed path, and senses the leading end of the sheet D sent to the vicinity of the ante-scanning roller 106. The discharge sensor S5 is arranged at the downstream of the post-scanning roller 107 as well as at the upstream of the discharge roller 108 on the sheet feed path, and senses the leading end of the sheet D passing through the post-scanning roller 107. The sensors S1 to S5 are, for example, optical sensors of reflection type.

The CPU 110 performs operation for various processing of the automatic document feeder 1, and the memory 111 stores various information utilized in the automatic document feeder 1 and programs etc. carried out in the CPU 110.

Next, the operation of the automatic document feeder 1 according to the embodiment will be explained.

In the above-described automatic document feeder 1, the pick-up roller 102 goes downward when a pick-up solenoid 112 (refer to FIG. 3) is turned ON, and the pick-up roller 102 and separating-feeding roller 103 are driven to be rotated when the feed motor M1 rotates forward.

The RGT roller 104 is driven to be rotated when the feed motor M1 rotates backward. The intermediate feeding roller 105, ante-scanning roller 106, and post-scanning roller 107 are driven to be rotated when the read motor M2 rotates forward. The discharge roller 108 is driven to be rotated when the discharge motor M3 rotates. In the embodiment, the motors M1 to M3 are all pulse motors.

In the above-described configuration, the CPU 110 corresponds to a speed information acquiring unit, the CPU 110 and the RGT sensor S2 correspond to temporal information acquiring units, and the CPU 110 corresponds to a control unit.

The CPU 110 acquires speed information concerning a scanning-feeding speed or the feeding speed of the sheet D whose image is to be scanned at the predetermined scanning position R (that is, a sheet feeding speed by the intermediate feeding roller 105, ante-scanning roller 106, and post-scanning roller 107) from the CPU 301. The scanning-feeding speed may be set up based on contents of an image scanning operation (image quality mode, scanning magnification, etc. at the time of scanning) by the image scanning apparatus 2, or may be set up based on contents of image formation operation by the image forming apparatus 3.

The CPU 110 acquires information concerning the start timing of sending the sheet D to the feed path (reception timing of feeding start requirement signal, start-up timing of pick-up roller, etc.). The RGT sensor S2 senses the arrival of the leading end of the sheet D sent to the feed path on the vicinity of the upstream of the RGT roller 104, and notifies the CPU 110 of the sense information. Thus, the CPU 110 acquires information concerning the timing of sensing the leading end of the sheet D by the RGT sensor S2 (sense timing etc.).

Using information concerning the start timing of sending the sheet D to the feed path and information concerning the arrival timing of the sheet D sent to the feed path on the vicinity of the upstream of the RGT roller 104, the CPU 110 calculates a time interval from the time point when sending a document to the feed path is started to the time point when thus sent document arrives at the vicinity of the upstream of the RGT roller.

Based on speed information acquired by the CPU 110 concerning an anterior document which is fed previously and temporal information acquired by the CPU 110 and the RGT sensor S2 arranged at the upstream of the RGT roller concerning a posterior document which is to be fed after the anterior document is fed, the CPU 110 controls the RGT roller 104 so that the posterior document is fed at a speed higher than the scanning-feeding speed of the anterior document.

The range in which the posterior document is fed at a speed higher than the scanning-feeding speed of the anterior document by the RGT roller 104 is set to be that from the RGT roller 104 to a predetermined speed change position P where the sheet feeding speed by the RGT roller 104 is changed to the scanning-feeding speed. The predetermined speed change position P is arranged between the RGT roller 104 and the vicinity of the intermediate feeding roller 105.

Specifically, a feeding speed V at which the posterior document is fed faster than the anterior document is calculated by the following mathematical expressions (1), (2), and (3), where a scanning-feeding speed of the anterior document is V1, a feed distance from the RGT roller to the predetermined speed change position P is L1, a time interval from the time point when sending the posterior document is started to the time point when the RGT sensor S2 senses the arrival of the posterior document on the vicinity of the upstream of the RGT roller is T1, a distance from the RGT roller to the intermediate feeding roller is L2, a standby time interval from the time point when the RGT sensor S2 senses the arrival of the posterior document on the vicinity of the upstream of the RGT roller to the time point when the RGT roller starts sending the posterior document is T2, a predetermined document spacing between the anterior document and the posterior document is L3.
(L1+L3)÷V1=(L2÷V)+(T1+T2) (1)
L2÷V=(L1+L3)÷V1−(T1+T2) (2)
V=L2÷((L1+L3)÷V1−(T1+T2)) (3)

Note that the mathematical expressions (1), (2) and (3) come into effect in the case of (L1+L3)÷V1>(T1+T2) alone. The predetermined document spacing L3 between the anterior document and the posterior document can be set up arbitrarily.

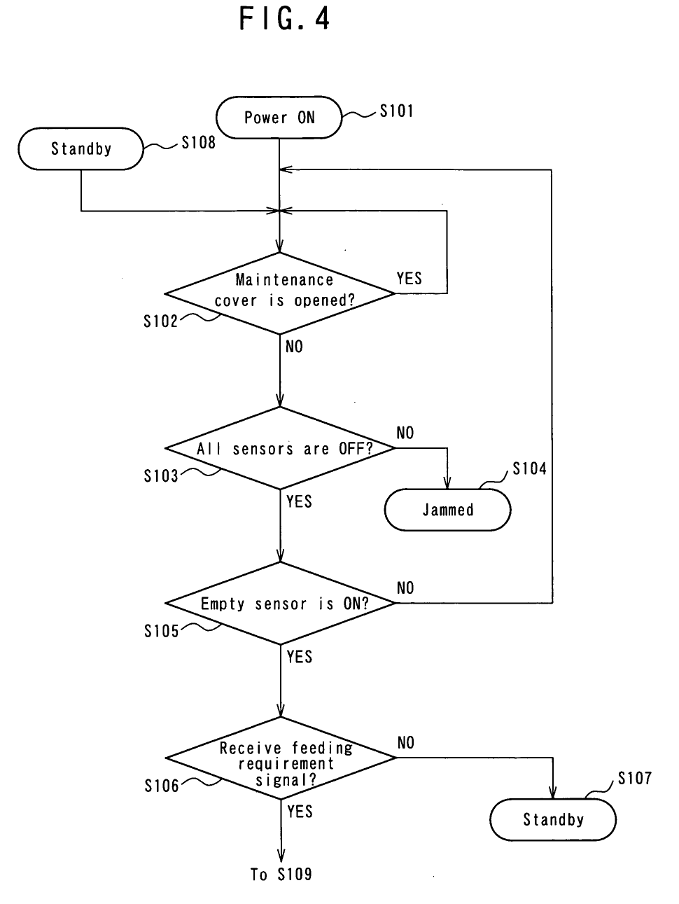

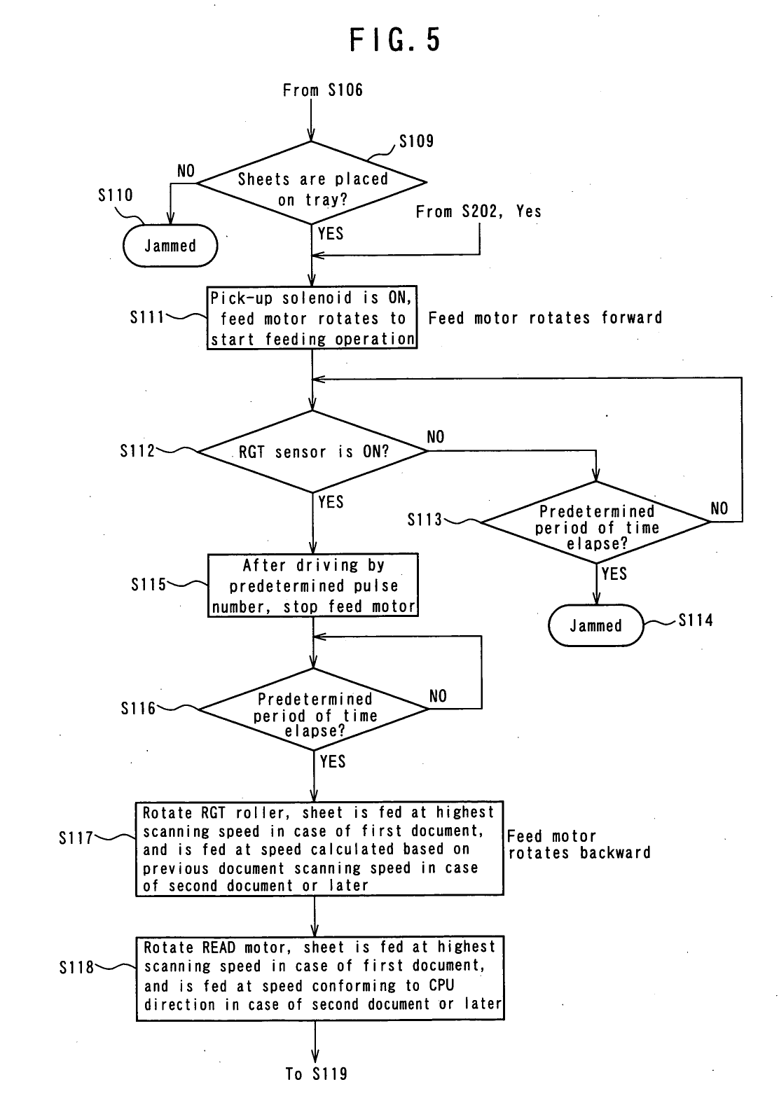

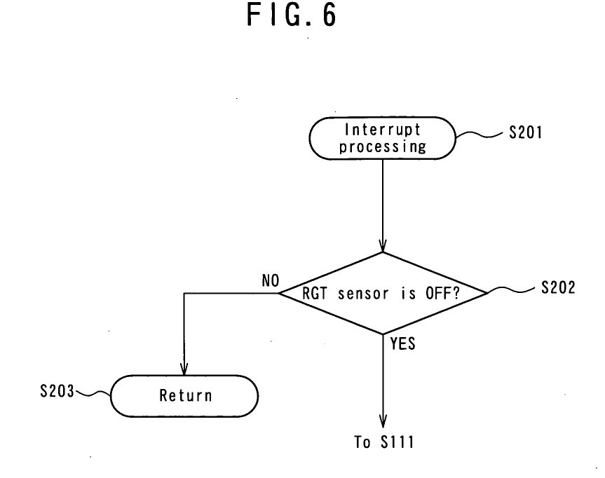

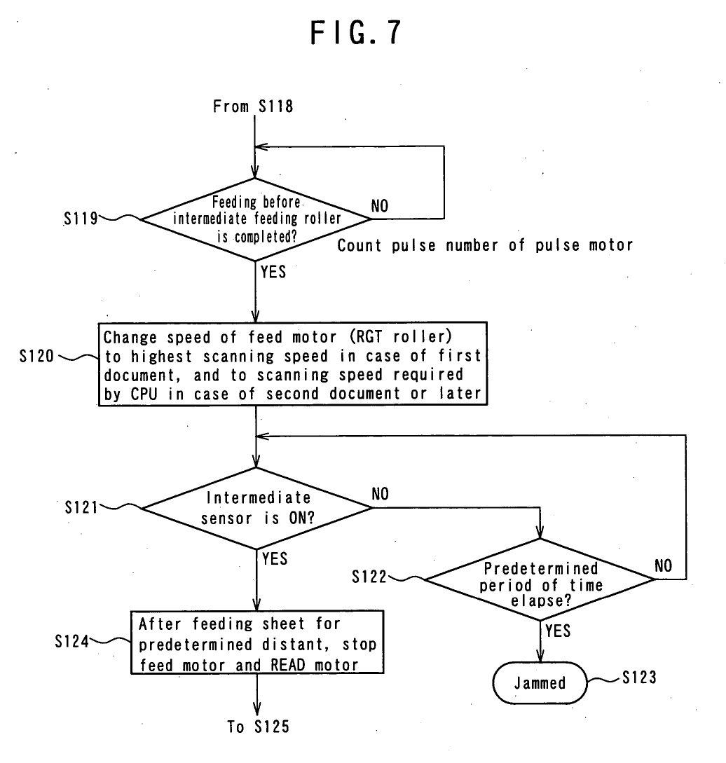

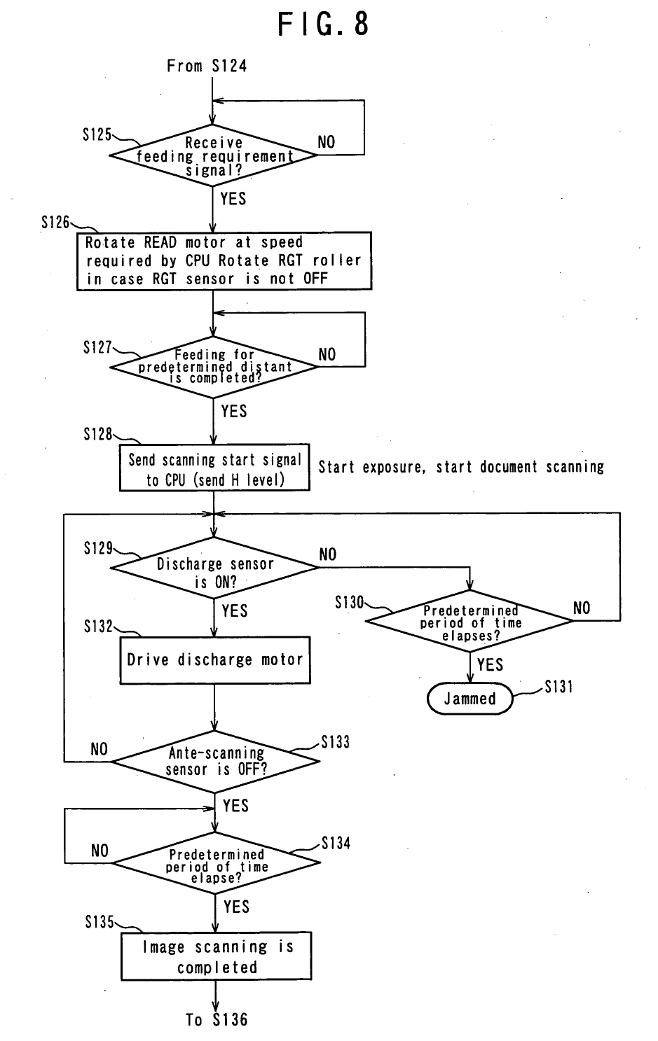

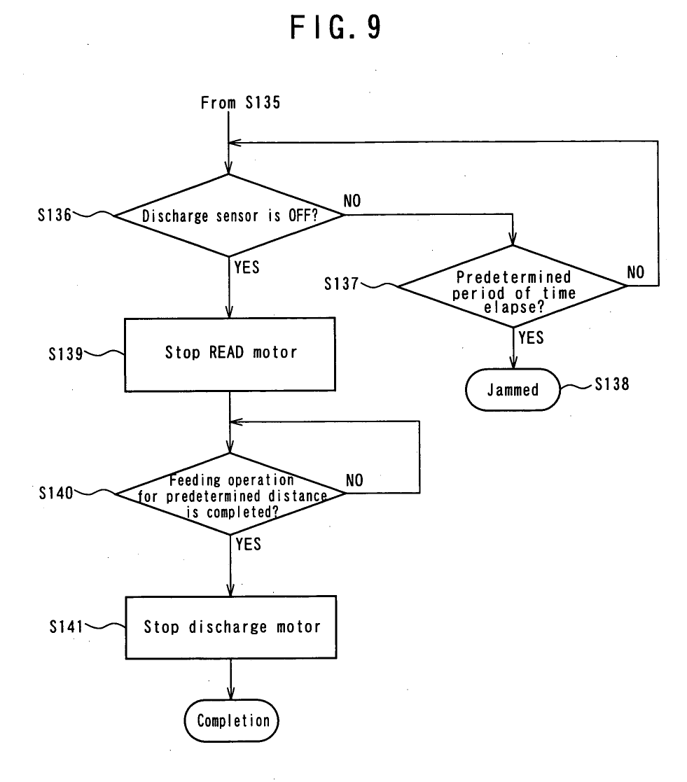

Next, the flow of the processing of the method for feeding a sheet using the image processing apparatus according to the embodiment will be explained with reference to the flow charts shown in FIG. 4 to FIG. 9.

When power of the automatic document feeder 1 is turned ON (S101) or is resumed from the standby state (S108), in case a maintenance cover for removing a document jammed on the feed path is opened (S102, Yes), the processing returns to check whether or not the maintenance cover is opened.

On the other hand, in case the maintenance cover is closed (S102, No), it is judged whether or not all the sensors for sensing sheet are OFF, and in case any one of the sensors is ON (S103, No), it is determined that the state is in a jammed state in which the sheet D is jammed on the feed path (S104).

In case all the sensors for sensing sheet are OFF (S103, Yes), it is judged whether or not an empty sensor S1 is ON, that is whether or not the sheets D are placed on the paper feed tray 101, and in case the empty sensor S1 is ON (S105, Yes), a document set ON signal is sent to the CPU 301. On the other hand, in case the empty sensor S1 is OFF (S105, No), the processing returns to above-described processing (S102).

Then, the processing comes into the standby state (S107) until the CPU 110 receives a feeding requirement signal from the CPU 301, and when the CPU 110 receives the feeding requirement signal from the CPU 301 (S106, Yes), it is judged whether or not the sheets D are placed on the paper feed tray 101 (S109). For example, when receiving the feeding requirement signal, the CPU 110 acquires speed information (feeding speed, the number of pulses per unit time, etc.) concerning the scanning-feeding speed of the sheet D whose image is to be scanned at the predetermined scanning position R from the CPU 301 (speed information acquiring step). At this time, in case the sheets D placed on the paper feed tray 101 are not sensed by the empty sensor S1 (S109, No), it is determined that the state is in the jammed state (S110).

In case the sheets D placed on the paper feed tray 101 are sensed (S109, Yes), the pick-up solenoid 112 is turned ON, and the feed motor M1 rotates forward to rotate the pick-up roller 102 and the separating-feeding roller 103 to start feeding operation (S111). The timing to start the feeding operation is the timing to start feeding the sheet D to the feed path.

Note that, as an interrupt processing (S201), it is judged whether or not the sheet D is periodically sensed by the RGT sensor S2 at a predetermined timing, and in case the sheet D is not sensed by the RGT sensor S2 (S202, Yes), feeding operation is started (S111), while in case the sheet D is sensed by the RGT sensor S2, feeding operation is not started (S203).

In case the leading end of the sheet D is sensed by the RGT sensor S2 (S112, Yes), after the leading end of the document is adjusted to be made to abut on the RGT roller 104 by driving the feed motor M1 by a predetermined pulse number, the feed motor M1 is stopped (S115). The leading end of the sheet D is sensed by the RGT sensor S2, and the CPU 110 acquires temporal information concerning a time interval from the time point when sending the sheet D is started to the time point when the sheet D arrives at the RGT sensor S2 (temporal information acquiring step).

In case the leading end of the sheet D is not sensed by the RGT sensor S2 (S112, No), and a predetermined period of time elapses (S113, Yes), it is determined that the state is in the jammed state (S114).

When a predetermined period of time elapses after the feed motor M1 is stopped (S116, Yes), the feed motor M1 is made to rotate backward to rotate the RGT roller 104 so as to send the sheet D to the intermediate feeding roller 105 (S117). The CPU 110 controls so that, in case the sheet D is the first document of the plural sheets D to be fed, the sheet D is fed at a highest speed under which the image scanning apparatus 2 can perform scanning, while in case the sheet D is the second document or later, based on the speed information and the temporal information acquired as in the above-described manner, the posterior document is fed by the RGT roller 104 at the speed V that is faster than the scanning-feeding speed V1 of the anterior document (control step). In this way, based on the scanning speed of the anterior document and a period of time required to send the document, the sheet feeding speed V by the RGT roller 104 is obtained using the mathematical expression (3), making it possible to feed sheets at a speed under which the spacing between the rear end of the anterior document and the leading end of the posterior document is kept suitable.

Next, at the same time as the RGT roller 104 is rotated, the read motor M2 is made to rotate (S118). At this time, the rotational speed of the read motor M2 is set up so that, in case the sheet D is the first document, the document is fed at a highest speed under which the image scanning apparatus 2 can perform scanning, while in case the sheet D is the second document or later, the document is fed at the scanning-feeding speed and under scanning magnification which conform to the direction from the CPU 301. At the time point when the feed motor M1 is rotated (RGT roller 104 is rotated) and the document is fed by predetermined pulses (speed change position P at the upstream of the intermediate feeding roller), the sheet feeding speed of the RGT roller 104 is made equal to that of the intermediate feeding roller 105. After driving the RGT roller 104 by a predetermined pulse number (S119, Yes), that is, when the leading end of the sheet D arrives at the predetermined speed change position P, the CPU 110 changes the sheet feeding speed (S120). Specifically, in case the sheet D is the first document, the sheet D is fed at a highest speed under which the image scanning apparatus 2 can perform scanning, while in case the sheet D is the second document or later, the sheet feeding speed is changed to the scanning-feeding speed which is required by the CPU 301.

Next, when the leading end of the sheet D is sensed by the intermediate sensor S3 (S121, Yes), after feeding the sheet D for a predetermined distant, the read motor M2 and the feed motor M1 are stopped (S124). In case the leading end of the sheet D is not sensed by the intermediate sensor S3 for a predetermined period of time or longer (S122, Yes), it is determined that the state is in the jammed state (S123).

Subsequently, when the CPU 110 receives the document feeding requirement signal from the CPU 301 (S125, Yes), the read motor M2 is made to rotate forward at a speed required by the CPU 301, and the feed motor M1 is made to rotate backward to rotate the intermediate feeding roller 105, ante-scanning roller 106, post-scanning roller 107, and RGT roller 104, and the scanning of the sheet D is started (S126).

When the sheet D is fed for a predetermined distant and after the rear end of the sheet D passes through the RGT roller 104 (S127, Yes), the feed motor M1 is once stopped, and then the feed motor M1 rotates forward to rotate the pick-up roller 102 and separating-feeding roller 103, and the sending of the next sheet D is started. The CPU 110 sends a scanning start signal to the CPU 301, and requires the image scanning unit 2 to start an image scanning operation (S128). Thus, the image scanning unit 2 starts exposure processing, and scans an image of the sheet D passing through the predetermined document scanning position R.

When the leading end of the sheet D whose image is scanned is sensed by the discharge sensor S5 (S129, Yes), the discharge motor M3 is started to be driven (S132) to drive and rotate the discharge roller 108, and discharges the sheet D. On the other hand, in case the discharge sensor S5 is not turned ON after a predetermined period of time elapses (S130, Yes), it is determined that the state is in the jammed state (S131).

Next, in case the sheet D is not sensed at the ante-scanning sensor S4, (S133, Yes), it is determined that the processing of scanning the image of the sheet D is completed, and after a predetermined period of time elapses (S134, Yes), image scanning processing by a CCD 201 at the image scanning unit 2 is completed (S135).

Next, in case the discharge sensor S5 is turned OFF (S136, Yes), the read motor M2 is stopped (S139) In case the discharge sensor S5 is not turned OFF within a predetermined period of time (S137, Yes), it is determined that the state is in the jammed state (S138).

In case the feeding operation for a predetermined distance by the discharge roller 108 is completed (S140, Yes), it is determined that the sheet D whose image is scanned is discharged by the discharge roller 108, and the discharge motor M3 is stopped (S141).

The above-described sheet feeding operation is repeated until the empty sensor S1 senses no sheet D on the paper feed tray 101.

The respective steps in above-described sheet feeding method (S101 to S141) can be realized by making a CPU (computer) carry out a sheet-feeding program stored in the memory (computer-readable storage medium) 111.

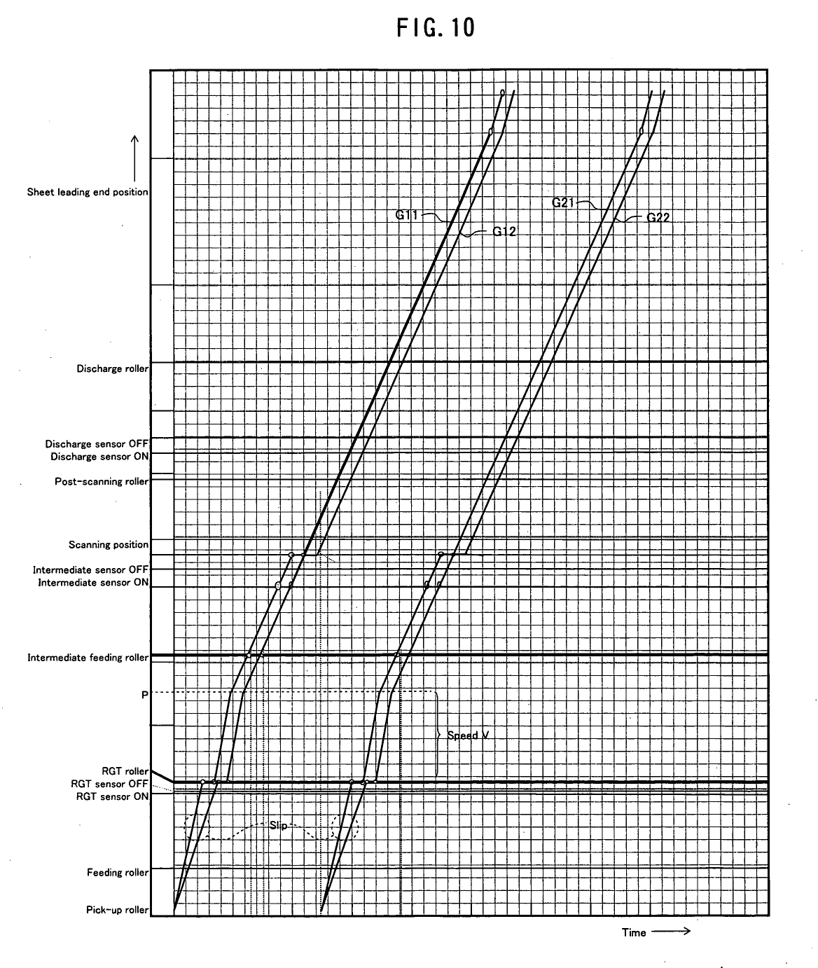

FIG. 10 shows a timing chart of sheet feeding by the automatic document feeder according to the embodiment. In FIG. 10, G12 and G22 show the relation between the position of the leading end of the sheet D to be fed and time in case there is raised a slip between the sheet D and the roller surface (in case there is raised a delay in sheet feeding) in the feeding operation by the pick-up roller 102 and separating-feeding roller 103, while G11 and G21 show the relation between the position of the leading end of the sheet D to be fed and time in case there is not raised a slip between the sheet D and the roller surface in the feeding operation. The G11 and G12 are graph of the first (anterior) sheet, while G21 and G22 are graph of the second (posterior) sheet.

As shown in FIG. 10, when the sheet feeding speed V by the RGT roller 104 from the RGT roller to the speed change position P is made faster than the scanning-feeding speed of the sheet D passing through the predetermined scanning position R, the spacing between the rear end of the anterior sheet and the leading end of the posterior sheet can be reduced.

According to the embodiment, since the feeding speed V to feed the sheet D is calculated in view of not only the scanning-feeding speed of the anterior sheet but also period of time required to feed the posterior sheet D to the vicinity of the RGT roller (a slip between the roller surface and the sheet in feeding a sheet), even though there is raised a slip between the roller surface and the sheet in feeding a sheet to the feed path, it can be seen that the rear end of the anterior document and the leading end of the posterior document can be kept suitable.

According to the embodiment, functions for carrying out the present invention are recorded in the apparatuses in advance. On the other hand, the same functions may be downloaded to the apparatuses from networks, or a recording medium having stored therein the same functions may be installed to the apparatuses. The recording medium may be of any configuration so long as programs can be stored and read out by the apparatuses, such as a CD-ROM. The functions obtained in advance by installing or downloading may be realized in cooperation with the OS (operating system) or the like.

As described above, according to the embodiment, the sheet spacing can be kept constant without carrying out complicated controls nor arranging sensors specially, and plural sheets can be fed with their sheet spacing kept suitable under the configuration of low cost.

While the present invention has been described in accordance with a certain preferred embodiment thereof in detail, it should be understood by those ordinarily skilled in the art that the invention is not limited to the above embodiment, but various modifications, alternative constructions or equivalents can be implemented without departing from the scope and spirit of the present invention.

As described above, according to the present invention, there can be provided a technique of feeding plural sheets while their sheet spacing kept suitable, with a simple configuration.

What is claimed is:

1. An automatic document feeder that consecutively feeds plural documents to a predetermined scanning position of an apparatus for scanning an image, comprising:
a speed information acquiring unit that acquires speed information concerning a scanning-feeding speed or the feeding speed of a document whose image is to be scanned at the predetermined scanning position;
a temporal information acquiring unit that acquires temporal information concerning a time interval from the time point when sending a document to a feed path is started to the time point when the sent document arrives at the vicinity of the upstream of a register roller that performs feeding timing adjustment for the sent document and feeds the document; and
a control unit that, based on speed information acquired by the speed information acquiring unit concerning an anterior document which is fed previously and temporal information acquired by the temporal information acquiring unit concerning a posterior document which is to be fed after the anterior document is fed, controls the register roller so that the posterior document is fed at a speed higher than the scanning-feeding speed of the anterior document.

2. The automatic document feeder according to claim 1, wherein the range in which the posterior document is fed at a speed higher than the scanning-feeding speed of the anterior document is set to be that from the register roller to a predetermined speed change position where the feeding speed by the register roller is changed to the scanning-feeding speed, the predetermined speed change position being arranged between the register roller and the vicinity of an intermediate feeding roller that is arranged at the upstream of the predetermined scanning position along the feeding direction.

3. The automatic document feeder according to claim 2, wherein, when a scanning-feeding speed of the anterior document is V1, a feed distance from the register roller to the predetermined speed change position is L1, a time interval from the time point when sending the posterior document is started to the time point when the posterior document arrives at the vicinity of the upstream of the register roller is T1, a distance from the register roller to the intermediate feeding roller is L2, a standby time interval from the time point when the posterior document arrives at the vicinity of the upstream of the register roller to the time point when the register roller starts sending the posterior document is T2, a predetermined document spacing between the anterior document and the posterior document is L3, and (L1+L3)÷V1>(T1+T2), a feeding speed V at which the posterior document is fed by the register roller is calculated by a mathematical expression of
V=L2÷((L1+L3)÷V1−(T1+T2))

4. An apparatus for scanning an image, comprising:
an automatic document feeder described in claim 1; and
an image scanning unit that scans an image of a document which is fed to the predetermined scanning position by the automatic document feeder,
wherein the scanning-feeding speed is set up based on contents of an image scanning operation by the image scanning unit.

5. An apparatus for processing an image, comprising:
an automatic document feeder described in claim 1;
an image scanning unit that scans an image of a document which is fed to the predetermined scanning position by the automatic document feeder; and
an image forming unit that forms an image which is scanned by the image scanning unit on a sheet,
wherein the scanning-feeding speed is set up based on contents of an image formation operation by the image forming unit.

6. A method for feeding a sheet that consecutively feeds plural documents to a predetermined scanning position of an apparatus for scanning an image, comprising:
a speed information acquiring step of acquiring speed information concerning a scanning-feeding speed or the feeding speed of a document whose image is to be scanned at the predetermined scanning position;
a temporal information acquiring step of acquiring temporal information concerning a time interval from the time point when sending a document to a feed path is started to the time point when the sent document arrives at the vicinity of the upstream of a register roller that performs feeding timing adjustment for the sent document and feeds the document; and
a control step of, based on speed information acquired at the speed information acquiring step concerning an anterior document which is fed previously and temporal information acquired at the temporal information acquiring step concerning a posterior document which is to be fed after the anterior document is fed, controlling the register roller so that the posterior document is fed at a speed higher than the scanning-feeding speed of the anterior document.

7. The method for feeding a sheet according to claim 6, wherein the range in which the posterior document is fed at a speed higher than the scanning-feeding speed of the anterior document is set to be that from the register roller to a predetermined speed change position where the feeding speed by the register roller is changed to the scanning-feeding speed, the predetermined speed change position being arranged between the register roller and the vicinity of an intermediate feeding roller that is arranged at the upstream of the predetermined scanning position along the feeding direction.

8. The method for feeding a sheet according to claim 6, wherein, when a scanning-feeding speed of the anterior document is V1, a feed distance from the register roller to the predetermined speed change position is L1, a time interval from the time point when sending the posterior document is started to the time point when the posterior document arrives at the vicinity of the upstream of the register roller is T1, a distance from the register roller to the intermediate feeding roller is L2, a standby time interval from the time point when the posterior document arrives at the vicinity of the upstream of the register roller to the time point when the register roller starts sending the posterior document is T2, a predetermined document spacing between the anterior document and the posterior document is L3, and (L1+L3)÷V1>(T1+T2), a feeding speed V at which the posterior document is fed by the register roller is calculated by a mathematical expression of
V=L2÷((L1+L3)÷V1−(T1+T2))

9. A program for feeding a sheet that makes a computer carry out the processing of consecutively feeding plural documents to a predetermined scanning position of an apparatus for scanning image, the program making the computer carry out:
a speed information acquiring step of acquiring speed information concerning a scanning-feeding speed or the feeding speed of a document whose image is to be scanned at the predetermined scanning position;
a temporal information acquiring step of acquiring temporal information concerning a time interval from the time point when sending a document to a feed path is started to the time point when the sent document arrives at the vicinity of the upstream of a register roller that performs feeding timing adjustment for the sent document and feeds the document; and
a control step of, based on speed information acquired at the speed information acquiring step concerning an anterior document which is fed previously and temporal information acquired at the temporal information acquiring step concerning a posterior document which is to be fed after the anterior document is fed, controlling the register roller so that the posterior document is fed at a speed higher than the scanning-feeding speed of the anterior document.

10. The program for feeding a sheet according to claim 9, wherein the range in which the posterior document is fed at a speed higher than the scanning-feeding speed of the anterior document is set to be that from the register roller to a predetermined speed change position where the feeding speed by the register roller is changed to the scanning-feeding speed, the predetermined speed change position being arranged between the register roller and the vicinity of an intermediate feeding roller that is arranged at the upstream of the predetermined scanning position along the feeding direction.

11. The program for feeding a sheet according to claim 9, wherein, when a scanning-feeding speed of the anterior document is V1, a feed distance from the register roller to the predetermined speed change position is L1, a time interval from the time point when sending the document is started to the time point when the posterior document arrives at the vicinity of the upstream of the register roller is T1, a distance from the register roller to the intermediate feeding roller is L2, a standby time interval from the time point when the posterior document arrives at the vicinity of the upstream of the register roller to the time point when the register roller starts sending the posterior document is T2, a predetermined document spacing between the anterior document and the posterior document is L3, and (L1+L3)÷V1>(T1+T2), a feeding speed V at which the posterior document is fed by the register roller is calculated by a mathematical expression of
V=L2÷((L1+L3)÷V1−(T1+T2))
